(19) United States
(12) Patent Application Publication
(10) Pub. No.: US 2010/0213009 A1
(43) Pub. Date: Aug. 26, 2010

(54) STABILIZING MECHANISM FOR LADDERS

(76) Inventors: Ruben Guinovart, Miami, FL (US); Andres Angel Vulcano, Hialeah, FL (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/774,406

(22) Filed: May 5, 2010

Related U.S. Application Data
(63) Continuation-in-part of application No. 12/144,444, filed on Jun. 23, 2008.
Application No. 12/144,444 is a continuation-in-part of application No. 12/060,331, filed on Apr. 1, 2008, now abandoned.

(51) Int. Cl. E06C 7/48

(52) U.S. Cl. 182/206

(57) ABSTRACT

A stabilizing mechanism for rigid fixed and extension ladders that includes an anchorage assembly removably mounted to one of the rungs of a ladder. A linkage assembly is mounted to the anchorage assembly through a transversally and rotably mounted elongated base that permits the setting of linkage assembly in one of several angular positions. Two arched arm members are pivotally mounted to a plate and also, with two linkage arms that are pivotally mounted to a swivel bracket, this two linkage assembly permits the arch members to move coplanarly between two extreme positions. The arm members releasably embrace a support structure thereby providing a firm engagement of the ladder to the support structure. A stabilizing pad assembly includes two pads mounted to adjustable elongate members to engage surrounding surfaces for more stability. A release mechanism remotely disengages the ladder from the support structure after a user descends from the ladder. The engagement is kept by a locking mechanism that includes a pivoting mounted plate with a central opening A shaft rigidly mounted to the rigid plate coacts in the edge of the centered opening to permit the shaft to move in on direction only.

### OTHER RELATED APPLICATIONS

The present application is a continuation-in-part of U.S. patent application Ser. No. 12/144,444, filed on Jun. 23, 2008, which is hereby incorporated by reference, and which in turn is a continuation-in-part of U.S. patent application Ser. No. 12/060,331 (now abandoned) filed on Apr. 1, 2008, which is hereby incorporated by reference.

### BACKGROUND OF THE INVENTION

1. Field of the Invention

The present invention relates to a stabilizing mechanism for ladders, and more particularly, to such a mechanism that permits a user to achieve a secure engagement remotely on a supporting object.

2. Description of the Related Art

In using straight ladders, typically a user leans a ladder against a supporting structure. The angle needs to be an adequate one to ensure the stability of the ladder. But in crowded areas, such as with urban utility poles, the space is limited. Thus, the desirability of having a mechanism for engaging a fixed structure, such as a pole, substantially vertically and parallel to the pole. Additionally, the arms assembly with the remotely releasable locking assembly ensures the safety of the users while providing a practical, efficient, and prompt manner of deployment.

Several designs for stabilizing mechanisms for ladders have been designed in the past. None of them, however, includes a mechanism that can be readily actuated. The parent application provides for a similar mechanism but it lacks stability for some applications.

Applicant believes that one of the related references corresponds to U.S. published application number 2010/0018803 A1 published on Jan. 28, 2010 listing Schwenket and Cinquemani as inventors. Schwenket and Cinquemani teach that apparatus 10 is put into contact with a supporting surface and to secure the calipers 28a and 28b of apparatus 10 around said surface, a user must climb the unsecured ladder and manually wrap chain 56 around the supporting surface and attach it to open hook 58.

However, it differs from the present invention because it does not offer the additional security to the user taught by the present invention. Schwenket and Cinquemani's application fails to disclose a locking system that is remotely actuated allowing the user to securely engage the ladder to the supporting surface while safely on the ground. In addition, the related reference does not teach of arms that are rotably able to move in order to provide engagements to other supporting surfaces (such as a roof or parapet wall).

Other patents describing the closest subject matter provide for a number of more or less complicated features that fail to solve the problem in an efficient and economical way. None of these patents suggest the novel features of the present invention.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of mechanism 10 mounted to a ladder represented in phantom.

FIG. 2 shows a bottom view of the mechanism shown in the previous figure.

FIG. 3 illustrates an elevational view of the back of the mechanism with the cover of housing member 32 removed.

FIG. 4 is an enlarged partial elevational view of member 25 seen from inside mechanism 10 with slidable claw 28 behind it.

FIG. 4A is an enlarged partial elevational view of members 25′ and claw 28′ from outside mechanism 10.

FIG. 5 is an enlarged partial isometric view of a portion of anchorage assembly 20 showing the engagement of pivoting claw 22 to member 25 which includes a cutout to permit the internal components to be seen.

FIG. 6 shows an enlarged partial isometric view of anchorage assembly 20 showing ratchet assembly 110 coacting with pivoting claw 22.

FIG. 6A illustrates a partial side elevational view of ratchet assembly 110, showing a cross-section of housing 111, ratchet pin 37 and pivot claw spring 113 coacting with engaging pin 115 in the retracted position.

FIG. 7 is a partial side elevational view of the lateral side of frame assembly 24 and bracket 226 mounted therein supporting housing assembly 30 which in turn supports linkage assembly 40.

FIG. 8 is a partial cutout of a side view showing housing assembly 30 and linkage assembly 40.

FIG. 9 shows an isometric view of supporting arms assembly 60 showing the embodiment including rubber pads 65 and 65′.

### DETAILED DESCRIPTION OF THE INVENTION

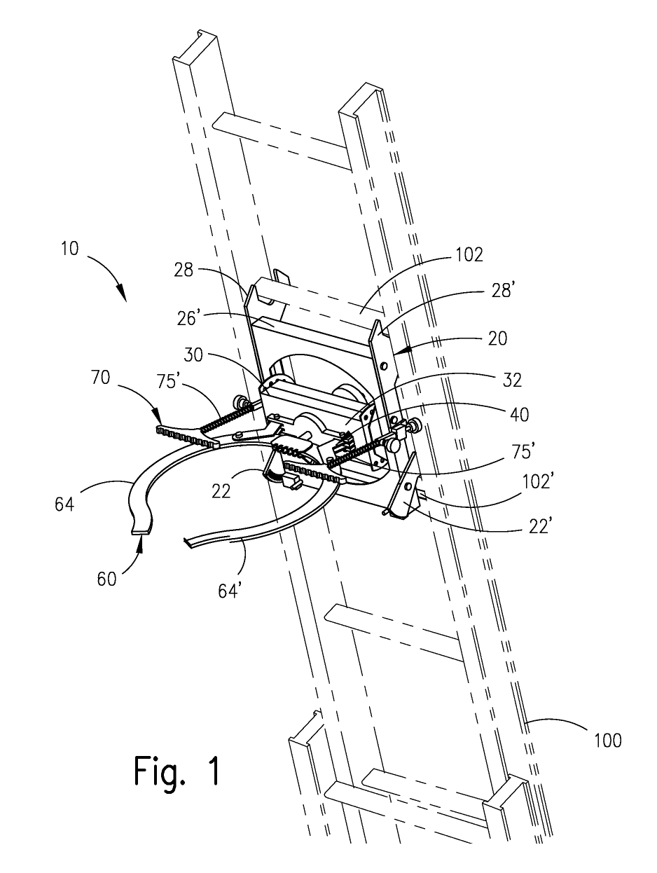

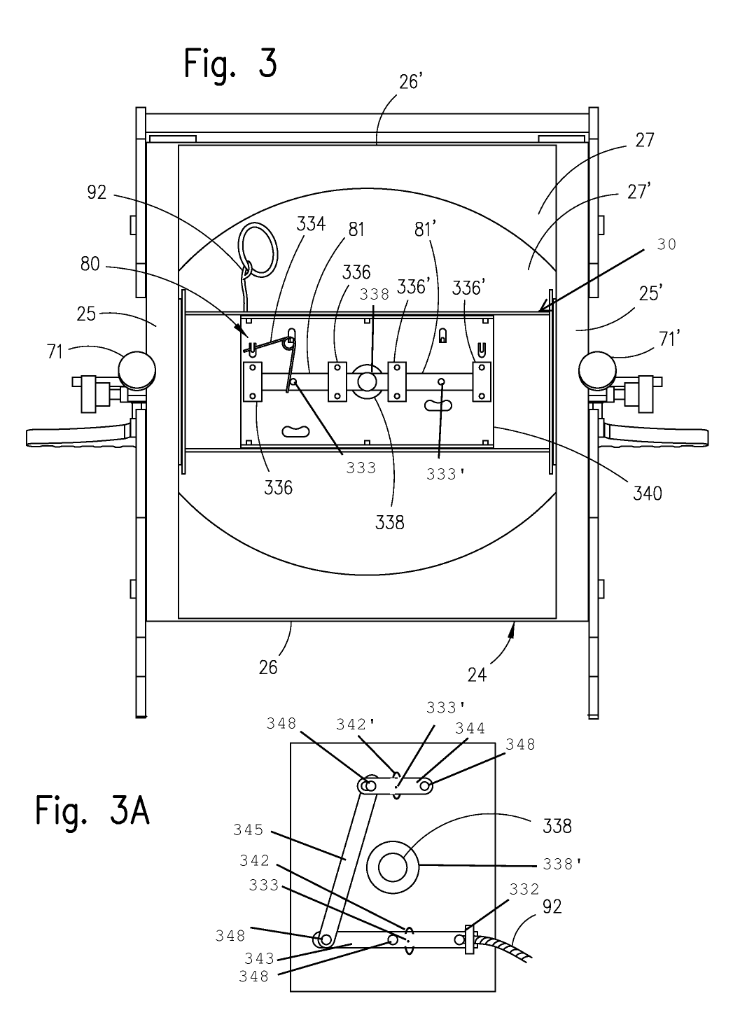

Referring now to the drawings, where the present invention is a mechanism generally referred to with numeral 10, it can be observed that it basically includes anchorage assembly 20, rotable housing assembly 30, linkage assembly 40, supporting arms assembly 60, stabilizing pad assembly 70, and locking assembly 80 (as best seen in FIG. 3). Mechanism 10 is removably mounted to a ladder 100, as seen in FIG. 1.

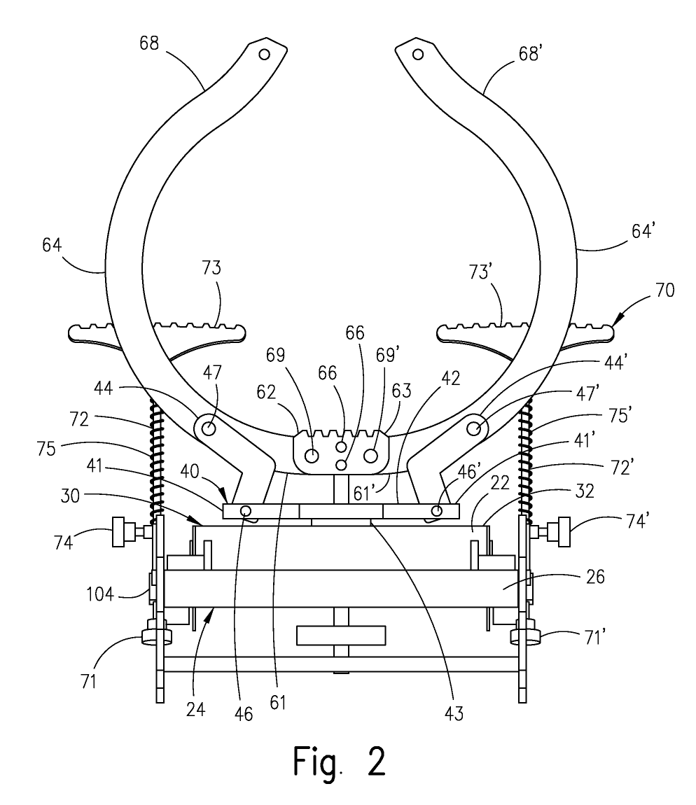

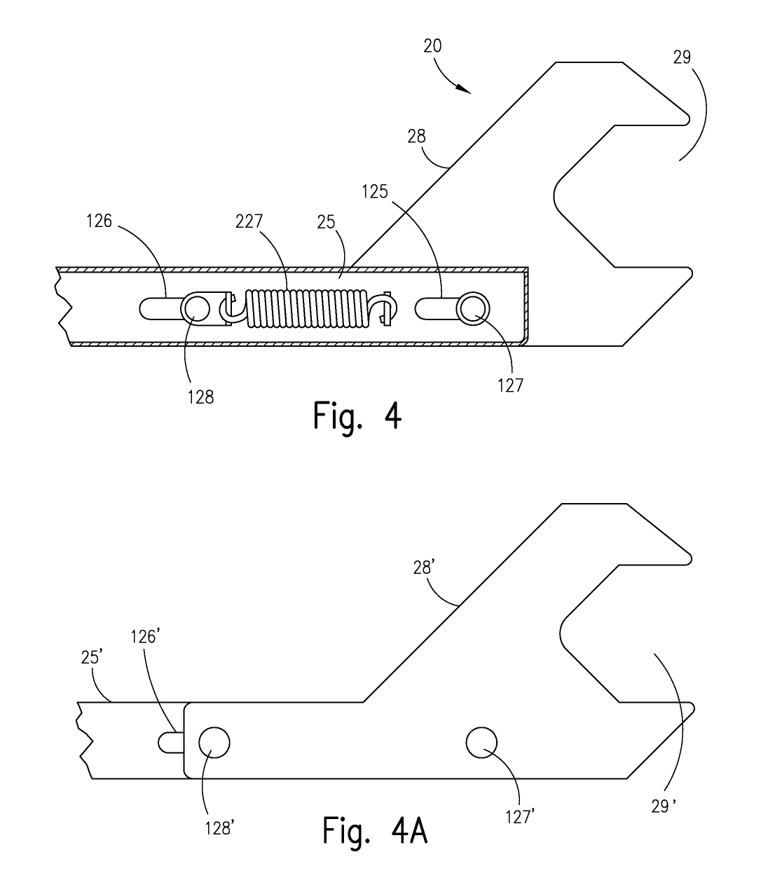

Anchorage assembly 20 is as best seen in FIG. 1 preferably mounted on ladder 100 at a predetermined distance from one end and the other end resting on a supporting and substantially horizontal surface (not shown). Anchorage assembly 20, as seen in FIGS. 2 and 3, includes frame assembly 24 which in turn includes longitudinal elongate members 25; 25′, which are kept at a parallel and spaced apart relationship with respect to each other by transversal elongate members 26; 26′ and transversal plate 27 including central aperture 27′. In one of the preferred embodiments, as best seen in FIG. 4, member 25 is a U-shaped bar for enhanced reinforcement and to provide a supporting surface for other components as it will be described below. Assembly 20 also includes a pair of slidable claws 28; 28′ and pivoting claws 22; 22′. The former are preferably mounted to the top rung in a ladder as shown in FIG. 1. Slidable claws 28; 28′ are spring biased and slidably mounted to the outer sides of elongate members 25; 25′ and include cutouts 29; 29′, respectively, that cooperatively receive rung 102 of ladder 100. See FIGS. 4 and 4A. As best seen in FIG. 4, claw 28 (and similarly claw 28′) is biased with slidable claw spring 227 (and similarly 227′). Member 25 includes slots 125 and 126 (and similarly 126′) for guiding headed pins 127 (and similarly 127′) and 128 (and similarly 128′), respectively. Thus, slidable claw 28 is biased to longitudinally extend outwardly to engage rung 102 and it can be retracted a predetermined distance when mechanism 10 is mounted to ladder 100.

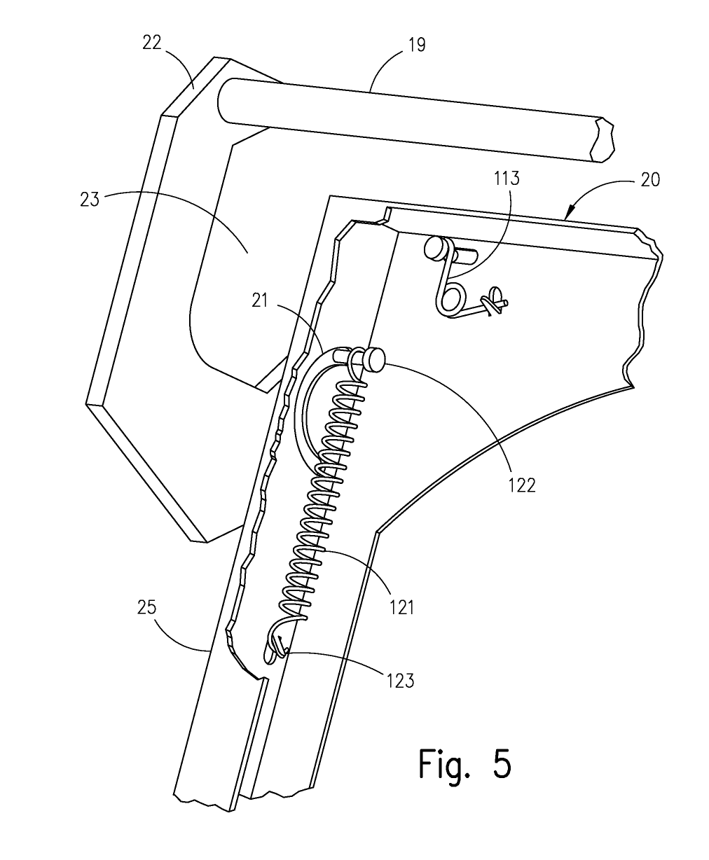

Pivoting claw 22 (and similarly 22′) are pivotally mounted to the outer side of member 25 (and similarly 25′) and pivoting headed pin 122 (and similarly 122′) are allowed to travel along a curved path defined by arched slot 21 (and similarly 21′) as best seen in FIG. 5. Bias spring 121 is secured at one end to tab 123 rigidly mounted to the interior member 25. The end of spring 121 (and similarly 121′) is mounted to pivoting pin 122 so that the latter is urged inwardly along the path of slot 21. Pivoting claw 22 (and similarly 22′) includes cutout 23 (and similarly 23′) that is similar to cutout 29 (and similarly 29′). Cutout 23 (and similarly 23′) receives rung 102′, as best seen in FIG. 1.

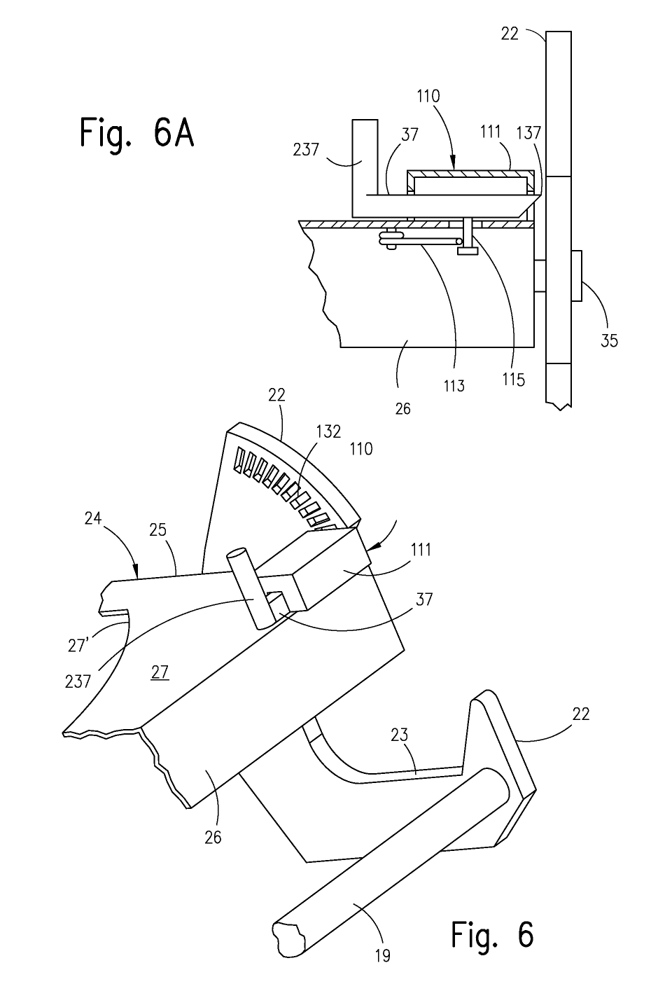

As best seen in FIGS. 1, 6, and 6A, anchorage assembly 20 also includes two ratchet assemblies 110; 110′ to permit pivot claws 22; 22′ to be releasably locked at predetermined angular positions with respect to frame assembly 24. In this extreme position, anchorage 20 is used to firmly mount mechanism 10 between two rungs 102 and 102′. The other extreme position has pivoting claws 22; 22′ at a retractable position that will permit the unobstructed positioning of assembly 20 between rungs 102 and 102′. Once positioned, pivoting claws 22; 22′ are moved through handle 19 to the other extreme position with cutouts 23; 23′ receiving rung 102′. Assemblies 110; 110′ include housings 111; 111′ mounted to transversal plate 27, adjacent to elongate member 25; 25′ and 26; 26′,respectively. As best seen in FIGS. 6 and 6A, where assembly 110 is shown (and assembly 110′ is similar), pin 37 is mounted substantially inside housing 111 with both ends protruding outwardly of housing 111. One end of pin 37 includes V-shaped tip 137 and the other includes perpendicularly extending lever 237. Tip 137 cooperatively engages ratchet cavities 132 to releasably keep pivoting claw 22 at a predetermined angular position. Upon the application of a force of a predetermined magnitude to handle 19, pivoting claw 22 is allowed to rotate in one direction. In the other direction, however, V-shaped tip 137 prevents its movement unless disengaged by pulling lever 237. Pivot claw spring 113 (and similarly 113′) coacts with engaging pin 115 (and similarly 115′) urging the latter outwardly until V-shaped tip 137 engages ratchet cavity 132. To release the engagement, a user pulls from lever 237. In this manner, anchorage assembly 20 is aligned between two rungs 102; 102′ causing cutouts 23; 23′ to receive rung 102′ (shown in FIG. 1). Pivoting claws 22; 22′ are brought from an angular position with respect to frame assembly 24 to the extreme position where cutouts 23; 23′ are aligned with cutouts 29; 29′ (as shown in FIG. 4), both sets housing rungs 102 and 102′ (as shown in FIG. 1).

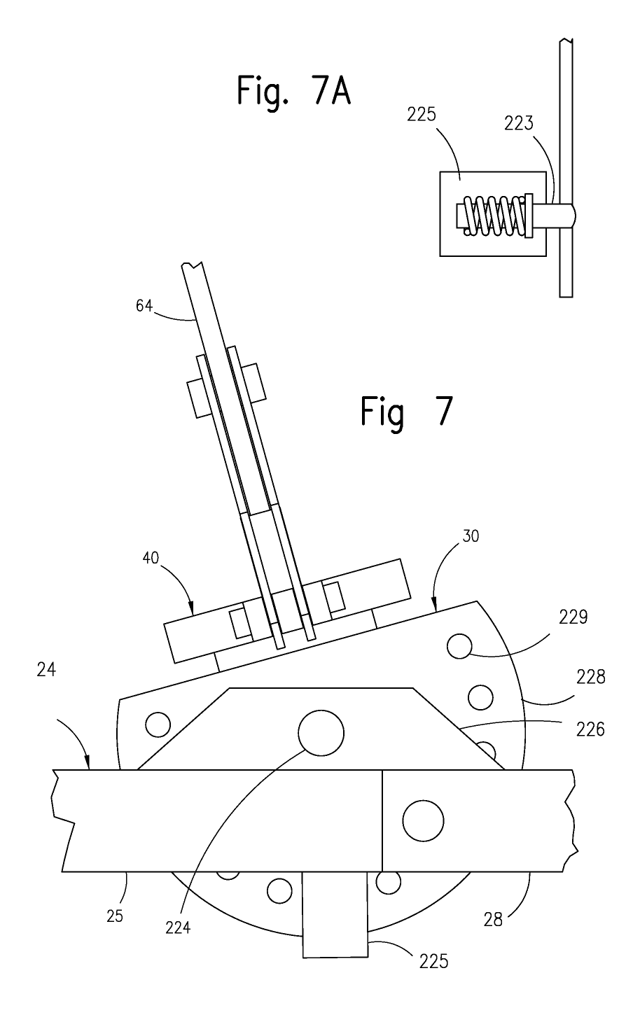

Housing assembly 30 (as best seen in FIG. 1) is rotably mounted to bracket 226 which in turn is mounted to frame 24. Assembly 30 includes housing member 32 which extends transversally inside central aperture 27′. Pivoting pins 224; 224′ are journaled by brackets 226; 226′ as seen in FIG. 7. Semicircular end plates 228 (and a similar end plate at the other end of housing member 32) include several through holes 229 adjacent to its periphery. Casing 225 is mounted to member 25 and the former includes spring-loaded pin 223 that releasably protrudes through through holes 229. Pin 223 is cammingly dislodged from through holes 229 upon the application of a force of a predetermined magnitude.

Linkage assembly 40 has linkage member 42 having an elongated shape with two ends 41; 41′. Assembly 40 is rotably mounted to housing assembly 30, as seen in FIG. 2. Linkage arms 44 and 44′ are pivotally mounted through pins 46 and 46′ to linkage member 42 at a predetermined distance from ends 41 and 41′, respectively, at one end of the linkage arms 44; 44′. The other ends of arms 44 and 44′ are pivotally mounted through pivot pins 47 and 47′ to arms 64 and 64′, respectively. Linkage arms 44; 44′ have been designated an L-shape in order to maximize the extreme open position of arched arm members 64; 64′. Linkage assembly 40 also includes shaft pins 66; 66′ which hold shaft 338 securely in place.

Arm assembly 60 includes arched arm members 64; 64′. Arm ends 61; 61′ are pivotally mounted to plate member 62 at predetermined locations through pivot pins 69; 69′, respectively. Therefore, arms 64; 64′ pivot about pins 69; 69′ while, at the same time, their movements are restricted by the pivoting engagement of pivoting pins 47; 47′ of linkage arms 44; 44′, which in turn pivot about pivoting pins 46; 46′. Plate member 62 includes rivets 66 to secure double-threaded shaft 338. Plate member 62 further includes teeth 63 which help increase the traction between mechanism 10 and a supporting object. Arms 64; 64′ are permitted to move between two extreme positions. Arm ends 68; 68′ include a slight curved shape to cooperatively and cammingly coact with an object (typically a pole, roof, tree, etc.) to cause the separation of arms 64; 64′.

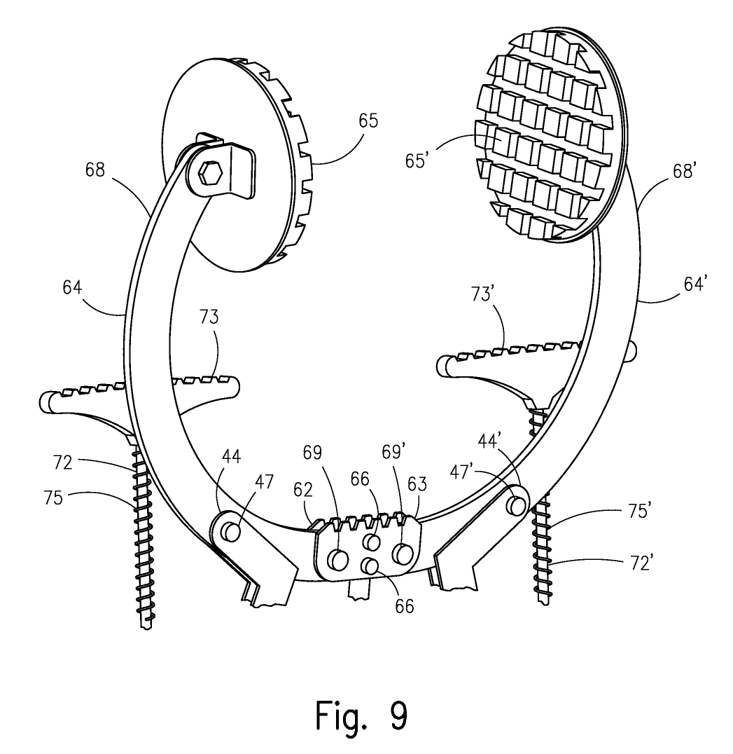

In an alternate embodiment shown in FIG. 9, distal ends of arms 64; 64′ of arm assembly 60 include rubber pads 65 and 65′ that are pivotally mounted thereon. Some functions for rubber pads 65 and 65′ include enhancing the frictional engagement to the supporting surface and to avoid scratching the contact surface. This embodiment for arched arms 64; 64′ is useful for flat surfaces such as roofs, overhangs, parapet walls, roof eaves, and the like.

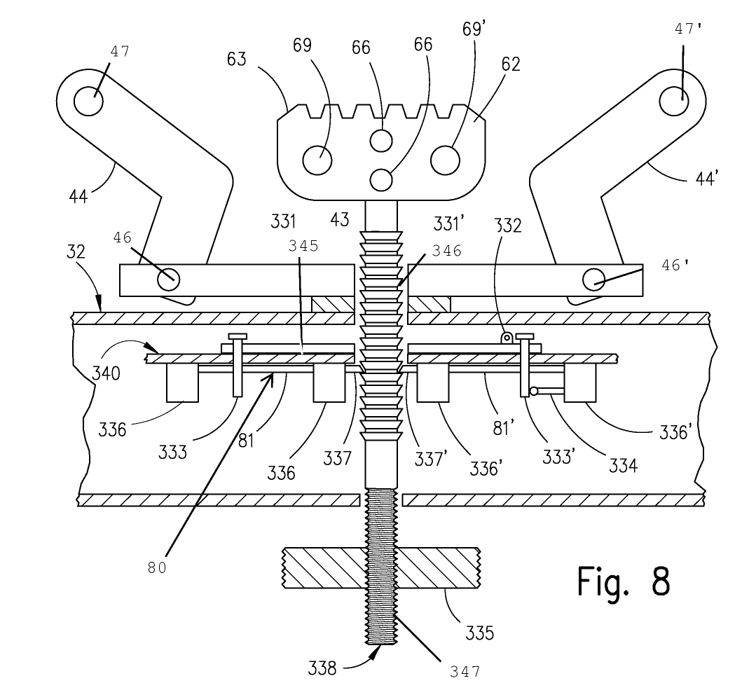

Locking assembly 80 is housed within frame assembly 24; as seen in FIG. 3. Locking assembly 80 releasably locks double-threaded shaft 338. The embodiment as shown in FIG. 3A and includes sub-housing 340 that is rigidally mounted to housing 30. Double-threaded shaft 338 is centrally located and passes perpendicularly through central opening 338′. Double-threaded shaft 338 includes a portion that has fin thread 346 as seen in FIG. 8. Chamferred nails 337; 337′ which are located on the distal ends of locking members 81; 81′, ratchedly engage fin thread 346 so that shaft 338 can move in one direction only. Locking members 81; 81′ are spring biased against shaft 338. To release the bias of locking members 81; 81′, against shaft 338, the embodiment shown in FIG. 3A has linkage arms 343; 344 and 345 articulated to transmit a pulling force imparted through cord 92. Actuating pins 333; 333′ are perpendicularly mounted to linkage member 343; 344 through guiding slots 342; 342′ to keep the movement of the articulated linkage members 343; 343′ over a predetermined distance. Actuating pin 333′ is coupled to coil spring 334 which exerts a force that biases actuating pin 333′, moving locking member 81 to the locking position. Locking member 81′ complements locking member 81 by engaging double-threaded shaft 338 from the opposite direction. Thus, locking members 81; 81′ create a secure engagement to double-threaded shaft 338. The end result is locking arched arm members 64; 64′ into a desired position. Locking member 81′ is coupled to actuating pin 333′ which is mounted to linkage arm 344 and biased to linkage arm 345. Conventional thread 347 of double-threaded shaft 338 mates with the internal thread of knurled knob 335 which is selectively brought against housing member 32 to lock shaft 338 in place. Knob 335 when brought against member 32 prevents shaft 338 from moving in the ratcheted direction.

Locking assembly 80 is actuated by cord 92 is mounted at one end to tab 332 in sub-housing 340. Tab 332 is on an end of linkage arm 343 and when cord 92 is pulled, linkage arm 343 is rotated about pivot pin 348 which in turn moves actuating pin 333′ along slot 342′. This causes locking member 81 to be pulled away from shaft 338. Actuating pin 333′ pushes coil spring 334 into a retracted position. Coil spring 334 allows locking member 81 to move away from shaft 338 in a controllable and secure pace. When cord 92 is pulled, linkage arm 343 urges transversal linkage arm 345 which urges linkage arm 344 since they are coupled with each other. As transversal linkage arm 345 urges linkage arm 344, actuating pin 333 moves laterally across slot 342 pulling locking member 81′ away from double-threaded shaft 338 thereby unlocking locking member 81′ from double-threaded shaft 338. Upon the release of cord 92 locking members 81; 81′ again engage shaft 338.

As best seen in FIG. 1, stabilizing pad assembly 70 is mounted to the lateral sides of longitudinal elongate members 25 and 25′. Stabilizing pad assembly 70 includes pad ends 71 and 71′, which are brought in contact with a supporting surface to provide a more secure engagement. Stabilizing pad assembly 70 also includes stabilizing elongate members 72 and 72′ which are connected to pad ends 71 and 71′. Stabilizing elongate members 72 and 72′ are also connected to top pads 73 and 73′. Stabilizing pad assembly 70 is locked into desired stabilizing position by turning locking knobs 74 and 74′. When a predetermined force is applied on top pads 73; 73′, stabilizing springs 75; 75′ compress pad ends 71; 71′ into the supporting surface. When stabilizing springs 75 and 75′ are distended, by unlocking knobs 74; 74′, stabilizing pad assembly 70 is disengaged from the supporting surface.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A stabilizing mechanism for rigid and extension ladders, comprising:
A) an anchorage assembly removably mounted to a ladder having a plurality of rungs between two parallel and spaced apart studs mounted to said rungs;
B) a housing assembly centrally and rotably mounted within said anchorage assembly;
C) a linkage assembly having a linkage member with first and second ends, said linkage member being rotably mounted to said housing assembly, said linkage assembly further including first and second linkage arms with third and fourth ends, said third ends of said first and second linkage arms being pivotally mounted to said linkage assembly at a location adjacent to said first and second ends, respectively;
D) an arms assembly including a rigid plate with fifth and sixth ends, and first and second arched arm members coplanarly disposed with respect to said rigid plate, each of said first and second arm members including each seventh and eighth ends, said seventh ends being pivotally mounted to said plate, and said first and second arm members each including pivoting pins and cooperative through holes located at a predetermined distance from said seventh ends to pivotally engage said fourth ends of said first and second linkage arms so that said first and second arched arms move coplanarly between two extreme positions that results in a solid gripping action over a cooperating support structure in an intermediate position; and
E) a locking assembly for releasably keeping said first and second arm members at predetermined positions cooperatively embracing a support structure thereby providing a firm engagement of said ladder to said support structure; and said locking mechanism being actuated on contact with said support structure.

2. The mechanism set forth in claim 1 further including:
F) first and second stabilizing pads mounted to first and second elongate members, respectively, said first and second elongate members having an adjustable effective length to selectively engage surrounding surfaces.

3. The mechanism set forth in claim 1 further including:
G) a base member substantially coextensive with said linkage assembly and transversally rotably mounted to said anchorage assembly and said linkage assembly being rotatably mounted on said base member so that said linkage and arm assemblies are permitted to move angularly along a centered longitudinal plane.

4. The mechanism set forth in claim 3 wherein said locking assembly includes a shaft perpendicularly mounted to said rigid plate and slidably passing through said linkage assembly and base member, including a spring biased locking plate pivotally mounted to said linkage assembly and further including a through hole which said shaft passes and the edge defining said through hole biting against said shaft to prevent any movement of the ladder when said locking plate is not perpendicular to said shaft.

5. The mechanism set forth in claim 4 wherein said locking assembly further includes a cord for remotely releasing said locking assembly by bringing said locking plate in a perpendicular relationship with respect to said shaft.

6. The mechanism set forth in claim 5 wherein said anchorage assembly includes two adjustable angular members having first and several lateral edges that are brought against said studs and further including a mounting bracket slidably mounted to said angular members, and said base member is mounted to said mounting bracket.

7. The mechanism set forth in claim 6 wherein said rungs are hollow and connected with coinciding holes in said studs, and said angular member including two spring based rung locking assembly cooperatively mounted substantially adjacent to said first and second edges to permit the engagement to said ladder's holes in it's studs.
